(19) United States
(12) Patent Application Publication
(10) Pub. No.: US 2006/0074716 A1
(43) Pub. Date: Apr. 6, 2006

(54) System and method for providing customized interactive and flexible nutritional counseling

(75) Inventors: Peter Tilles, Skillman, NJ (US); Matthew B. Hobbs, Brooklyn, NY (US); Roland M. Chemtob, New York City, NY (US); Stephen J. Godfrey, New York City, NY (US)

Correspondence Address: SYNNESTVEDT & LECHNER, LLP, 2600 ARAMARK TOWER, 1101 MARKET STREET, PHILADELPHIA, PA, 191072950, US

(73) Assignee: Fountain Mobile, New York City, NY (US)

(21) Appl. No.: 11/217,186

(22) Filed: Sep. 1, 2005

Related U.S. Application Data
(60) Provisional application No. 60/606,219, filed on Sep. 1, 2004.

(51) Int. Cl. G06Q 10/00

(52) U.S. Cl. 705/2

(57) ABSTRACT

A system provides via multiple communications channels flexible nutritional counseling that encourages users to adhere to a sensible diet. The system may recommend a compliant meal having nutritional content that is within certain dietary parameters applicable to the user. However, the system may also recommend a non-compliant meal having nutritional content that is not within the dietary parameters, but is a sensible choice in view of constraints that make it impossible or infeasible to select a compliant meal. Thus, the system may recommend a meal that is not an optimal selection, but that is a best selection from among a set of non-compliant options. Accordingly, the user has flexibility to deviate from optimal choices as practically necessary or desirable. The user confirms meals actually consumed, and the system can account for an indulgence when recommending a next meal, and/or send a motivational message to the user encouraging compliant behavior.

### CROSS-REFERENCE TO RELATED APPLICATION

This application claims the benefit of U.S. Provisional Patent Application No. 60/606,219, filed Sep. 1, 2004, the entire disclosure of which is hereby incorporated herein by reference.

### FIELD OF THE INVENTION

The present invention relates generally to a computerized system for managing an individual's diet, and more specifically, to an interactive computerized system for providing nutritional counseling customized for the individual.

### DISCUSSION OF THE RELATED ART

Various meal planning and diet management tools are known in the art. Such tools often include computer systems capable of analyzing nutritional content of food items for the purpose of achieving a health related goal, such as weight loss (e.g., low calorie, low fat), allergen avoidance (e.g., no milk products, no peanuts, etc.), health maintenance (e.g., low sodium, low fat), or dietary preference (e.g., vegetarian). To achieve such a goal, a user profile is developed for the individual. By way of example, the user profile may include or reflect person-specific information, such as age, sex, height, weight, known allergies, known health conditions, prescribed diet constraints, etc.

Accordingly, a computerized system may generate a meal plan that matches a user's profile. An exemplary system for generating a meal plan that matches a predetermined user's profile is disclosed in U.S. Patent Publication No. 2002/0046060 to Hoskyns et al., the entire disclosure of which is hereby incorporated herein by reference. Another system is disclosed in U.S. Patent Publication No. 2003/0208409 to Mault, the entire disclosure of which is hereby incorporated herein by reference. For example, the system may generate a meal plan consisting of 4 oz. of broiled salmon and 3 oz. of steamed broccoli for a user that seeks low fat, low calorie meals.

While generating a meal plan may be helpful in assisting a user to achieve certain dietary goals, a user likely will not want to or be able to adhere, for every meal, to the system's generated meal plan. If the user does not adhere to the generated meal plan, there is little or no guidance for the user, which may result in a poor, or hazardous, selection of an unhealthy alternative meal, e.g. a bacon, double-cheeseburger, cheese-fries and a chocolate milkshake. U.S. Patent Publication No. 2002/0046060 to Hoskyns et al. attempts to address this concern by allowing a user to exchange a generated meal plan matching the user's profile if the user does not want to accept the generated meal plan, etc. More specifically, the user may elect to exchange the original meal, at which point the user is presented with selectable alternative meals that also match the user's profile, i.e., within a carbohydrate/protein/fat ratio applicable to the user, and applicable to the original meal.

It is believed that neither Hoskyns' system nor other known systems provide sufficient flexibility to retain a user on a prescribed dietary regimen in cooperation with the system. For example, if a user in the context of Hoskyns does not prefer any of the alternative meals matching the user's profile, then the user is just as likely to consume, as an alternative to the original meal, the exemplary unhealthy bacon, double-cheeseburger, cheese-fries and chocolate milkshake meal described above. By way of further example, if a user is preparing to take her children to lunch at a fast food chain restaurant, or if the user is scheduled to participate in a business meeting at an ethnic restaurant, it is highly unlikely that the user will be able to meet those obligations and have a meal selected from the list of generate meals matching the user's profile. Therefore, as a result of daily pressures, obligations and other practicalities, users tend to discontinue their adherence to a prescribed dietary regimen, and to abandon use of any dietary planning tool/system, after a relatively short period of time. This prevents achievement of the user's goals and obtaining of the full benefit of such systems.

### SUMMARY OF THE INVENTION

The present invention provides a system and method for providing customized, interactive and flexible nutritional counseling that encourages users to continue their adherence to a prescribed dietary regimen. The system may provide such counseling to multiple users via multiple different communications channels.

In one embodiment, the method involves receiving user information and developing a user profile as a function of the user information, the profile being associated with certain dietary parameters. The method further involves receiving, via a communications network, a request from the user for a meal having a certain characteristic, such as “available at a Chinese restaurant”, and searching a database of nutritional information to identify whether any meal having the certain characteristic has nutritional content values that are within said dietary parameters. If no meal having the certain characteristic has nutritional content values that are within said dietary parameters, then the system identifies a non-compliant meal for the user that does not have nutritional content values that are within said dietary parameters, but that is more closely compatible with the dietary parameters than another meal having the certain characteristic. This enhances the flexibility of the system and promotes adherence to the system's recommendations. Further, the method involves transmitting to the user meal information identifying the non-compliant meal as a recommended meal. Accordingly, a meal that would not otherwise be recommended given the user's profile and health characteristics/goals may nevertheless be recommended in a particular context, e.g., when the user is going, regardless of an optimal meal selection, to a restaurant where no optimal meal selection is available.

Preferably, the system is configured to allow the user to confirm meals actually consumed. This information may be used by the system in developing a user profile, and/or in planning a recommendation for a next meal, e.g. to account for any indulgences or indiscretions in a prior meal consumed.

In one embodiment, recommended meals are sent to a user on a recurring, predetermined basis, e.g. to a user's cell phone. Regardless of whether any recommended meals are pushed to the user, and regardless of whether any profile is established for the user, the user may make requests of the system and the system will make responsive recommendations. For example, if the user has no profile, the system may simply suggest a sensible meal, e.g. a salad from a fast food chain restaurant. If the user is recognized by the system, but has not developed a customized profile for use in recommending a meal, a system default profile may be used, e.g. for moderate/low calorie or general health maintenance. In a certain embodiment, the user can communicate repeatedly with the system, in an interactive manner, in developing a recommended meal in an iterative fashion, from a set of broad criteria to a set of narrower criteria, e.g., requesting a Chinese meal, requesting a Chinese meal including chicken, and then requesting a Chinese meal including chicken and excluding peanuts.

### BRIEF DESCRIPTION OF THE DRAWINGS

The present invention will now be described by way of example with reference to the following drawings in which:

FIG. 1 is a schematic diagram illustrating diagrammatically exemplary communications between a user and the system;

FIG. 2 is a flow diagram illustrating an exemplary method for providing customized, interactive and flexible nutritional counseling in accordance with the present invention; and

FIG. 3 is a block diagram of an exemplary server computer in accordance with the present invention.

### DETAILED DESCRIPTION

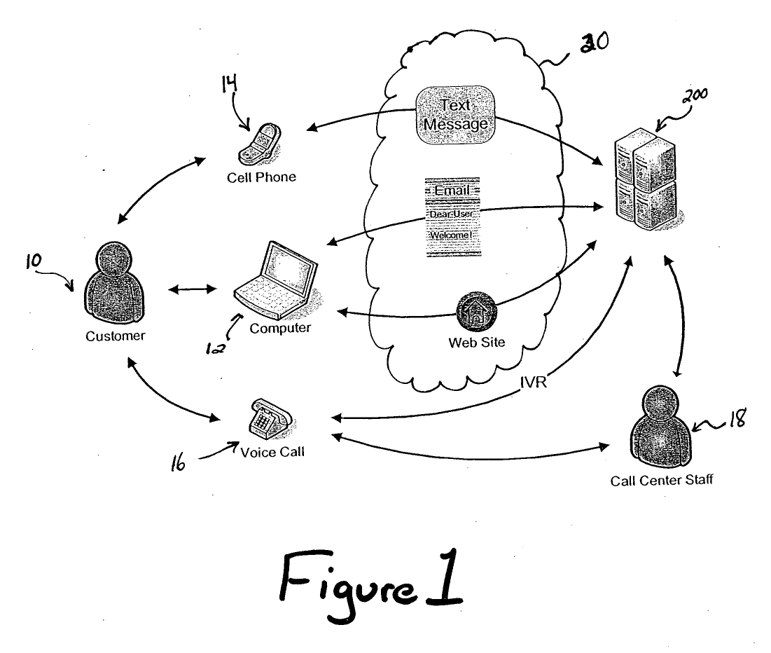

The present invention provides a system and method for providing customized, interactive and flexible nutritional counseling. The system may provide such counseling to multiple users, and to a single user via multiple different communications channels. FIG. 1 is a schematic diagram illustrating diagrammatically exemplary communication channels between a user 10 and the system's server computer(s), shown logically as a single server 200.

As shown in FIG. 1, one communications channel involves a user's access of the system 200 via a desktop, laptop, notebook, tablet or similar device 12 to communicate via a communications network 20, such as the Internet, with the server 200, using conventional communications hardware, software, and technologies. For example, an e-mail or website interface may be provided for this purpose. Accordingly, this channel is particularly well-suited to use at home, at work, etc.

Another communications channel involves a user's access of the system 200 via a mobile computing device 14, such as a wireless telephone, PDA, etc. For example, the device may be configured to use MMS, SMS text messaging, IM instant messaging technology, an e-mail interface, web or WAP interface, etc., using conventional communications hardware, software and technologies. Accordingly, this channel is particularly well-suited to use at a restaurant, en route to a restaurant, etc.

Yet another channel involves a user's access of the system via a wireless or conventional wired telephone 16 to access an automated Interactive Voice Response (IVR) system interface of the server 200. Such IVR systems may be implemented using conventional communications hardware, software and technologies. Alternatively, the telephone 16 may be used to communicate with a human call center staffer 18 who may interface with a client device in communication with the system 200.

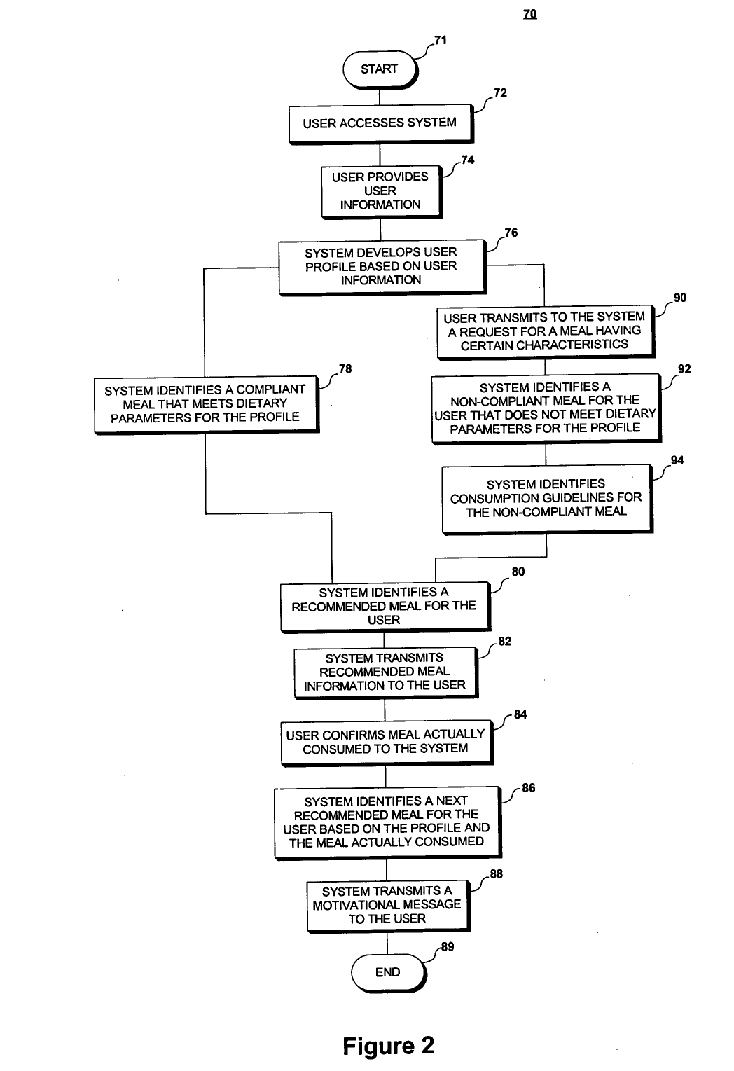

FIG. 2 is a flow diagram illustrating an exemplary method for providing customized, interactive and flexible nutritional counseling in accordance with the present invention. Referring now to FIGS. 1 and 2, the exemplary flow diagram 70 begins with the user's access of the system 200, which may be accomplished via an appropriate communications channel, as discussed above with reference to FIG. 1. It will be appreciated that the system may provide counseling to numerous users concurrently.

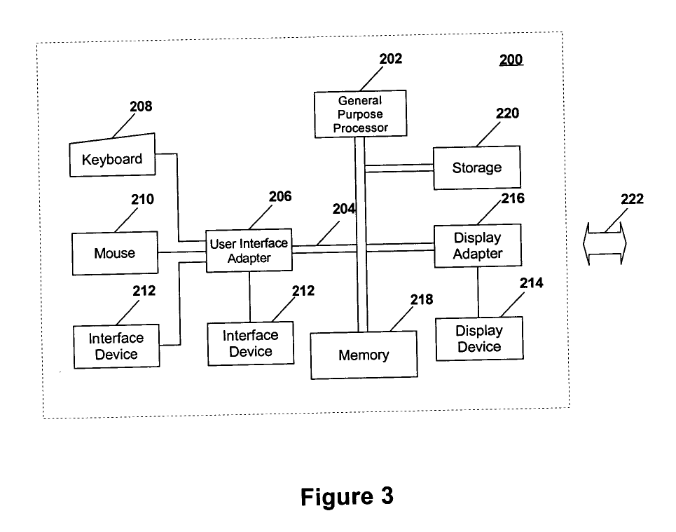

FIG. 3 is a block diagram of a server computer 200 in accordance with the present invention. The server 200, which includes conventional server hardware storing and executing specially configured computer software for carrying out a method in accordance with the present invention. Further such conventional hardware is configured with specially configured server software for performing the functionality described above.

Accordingly, the server 200 of FIG. 3 includes a general purpose microprocessor (CPU) 202 and a bus 204 employed to connect and enable communication between the microprocessor 202 and the components of the server 200 in accordance with known techniques. The server 200 typically includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the microprocessor 202 via a display adapter 216. The bus 204 also connects the microprocessor 202 to memory 218 and long-term storage 220 (collectively, “memory”) which can include a hard drive, diskette drive, tape drive, etc.

The server 200 may communicate with other computers or networks of computers, for example via a communications channel, network card or modem 222. The server 200 may be associated with such other computers in a local area network (LAN) or a wide area network (WAN), and operates as a server in a client/server arrangement with another computer, etc. Such configurations, as well as the appropriate communications hardware and software, are known in the art.

The server's software is specially configured in accordance with the present invention. Accordingly, as shown in FIG. 3, the server 200 includes various software-implemented components, including a communications parser for parsing communications received from a user, e.g. via e-mail message, text message, etc. Software programming code for carrying out the inventive method is typically stored in memory. Accordingly, the server stores in its memory microprocessor executable instructions including programs for carrying out the method described herein. For example, the server 200 stores in its memory 220 instructions configured to obtain and store user information, instructions configured to develop, identify and/or assign a user profile to a user, instructions configured to exchange information with a user, instructions configured to recommend a compliant food item/meal (collectively, “meal”) that matches and/or falls within acceptable parameters corresponding to the user's profile information, instructions configured to recommend a non-compliant meal that does not match and/or does not fall within acceptable parameters corresponding to the user's profile information but otherwise matches a user's request, instructions configured to identify a next recommended meal to nutritionally compensate for a previously consumed meal, and instructions configured to transmit a relevant motivational message to a user.

The server 200 also stores in its memory 220 a database of user profile information that includes one or more default profiles as well as customized user profiles built as users register with the system, a database of food consumption for each user, and a database comprising nutritional information for various food items, meals, diets, etc., The nutritional information may include nutritional content information, such as carbohydrate, protein, fat and calorie content, ingredient information for various meals, food consumption guidelines corresponding to recommendations and standards, medical conditions, diet objectives, etc. Accordingly, for example, the database of nutritional information may include, for each food item, calories, calories from carbohydrates, calories from fat, calories from protein, total fat, saturate fat, cholesterol, sodium, total carbohydrate, dietary fiber, starch, sugars, and protein content, etc. The database of nutritional information may also include recommended food portion sizes and weights, a listing of ingredients, etc. By way of example, nutritional information may be obtained by adapting the USDA Nutritional Database SR16-1; a database of recipes/ingredients may be created or obtained.

The server 200 also stores in its memory 220 a database of motivational messages. The motivational messages may be in audio, video or textual form, and are designed to encourage a user of the system to adhere to dietary parameters, to continue using the system, to continue to make sensible meal choices, etc. By way of example, the motivational messages may be pre-recorded messages, e.g. in digital form, that convey congratulations, encouragement, disappointment, or cautionary messages specific to a non-conforming meal that was requested, etc. Optionally, the motivational messages may be recorded by a recognizable celebrity, and the user may choose, e.g. during registration with the system, which celebrity will deliver his/her motivational messages.

Referring again to FIG. 2, the exemplary method next involves a user's providing of user information, as shown at step 74. This user information is received by the server 200 via a communications network. By way of example, the user information may include contact information, registered user device information, dietary preference information, and personal information, such as age, sex, height, weight, known allergies, known health conditions, prescribed diet constraints, health related goal information, eating habits/frequency/times, etc., and may be obtained from the user by providing a questionnaire for completion by the user. The information may be provided to the server 200 using the user's device 12, 14, 16.

In an alternative embodiment, the user is not required to answer questions and develop a customized profile before using the system. Instead, a new user may be initially assigned a predetermined default profile, e.g. a “healthy living” profile. Optionally, the default profile may eventually be replaced within the system by a customized profile. The customized profile may be developed explicitly by asking the user to answer questions, or implicitly, by developing a profile based on the meals confirmed as having been actually consumed by the user. For example, if the user never confirms having eaten a meal including pork, then the system may add to the profile information that will result in an exclusion of pork. Alternatively, patterns in multiple meals consumed may be used to develop a profile, e.g. “vegetarian.” By way of example, the user may be asked to provide via questionnaire, basic contact information, body characteristics and information, diet goals, food preferences, dietary likes and dislikes, dietary preferences, religious restrictions, whether the user will cook at home or at a restaurant, food exclusions/allergies, past meals, PCF ratio, eating habits, times and patterns, etc.

In the exemplary embodiment of FIG. 2, the server 200 then develops a user profile based on the user information provided, as shown at step 76. User profile information may be stored in a user information database in a memory 220 of the server 200. Development of a user profile for the user may be performed using known techniques, but will include health specific information that will allow for identification of dietary parameters that are suitable for the user. Preferably, the profile is defined as a function of the user information and is selected from one of a plurality of predefined profiles stored in a database of profile information stored in the memory 220 of the server 200. Alternatively, a generic default profile may be used. The profiles may be stored in a user profile database in the memory 220 of the server 200. Each profile stored in the database is associated with certain dietary parameters, e.g. low salt, low fat, high fiber, heart healthy, 2000 calories per day, etc. The profile may express the dietary parameters in qualitative and/or quantitative terms. The matching of the user's profile to dietary parameters may be made by a processor referencing the database of user profiles.

Recommendation of Compliant Meal

As discussed above, the server 200 also stores in its memory 220 a database of nutritional information. Accordingly, after the profile is defined, the server, or more specifically a recommendation engine implemented by specially configured software/instructions in accordance with the present invention and stored in the memory 220, can recommend meals based on the nutritional content information for various meals/food items and the user's profile.

Accordingly, the server 200 may next identify a compliant meal for the user as a function of the user's profile, i.e. a meal that has nutritional content values (e.g. grams of fat, carbohydrates, or protein, calories, high fiber, below a certain threshold in milligrams of sodium, vegetarian/kosher or other lifestyle characteristics, included ingredients, excluded ingredients, etc.) that meet and are within the dietary parameters for the user's profile, as shown at step 78. The compliant meals are those that are best suited for the user's profile, i.e., match the user's nutritional goals, requirements, etc., and thus are of the type that the system will recommend when given an opportunity to select between compliant and non-compliant meals. This allows the user to receive the maximum benefit from the system, and to best achieve his health goals.

By way of example, the server's recommendation engine may consider one or more of the following: dietary likes and dislikes as provided by the user in response to a questionnaire, or as inferred from meals confirmed as consumed; dietary preferences; religious restrictions; whether the user will cook at home or at a restaurant, food exclusions/allergies; past meals, e.g. to provide variety; PCF ratio or other nutritional content values in view of a user's profile; eating patterns; RDA levels, etc.

Recommendation of Non-Compliant Meal

In addition to recommending compliant meals to maximize goal achievement for the user, the inventive system/server 200 also has the capability of recommending non-compliant meals to the user in the event that it is impractical for the user to adhere to the recommendation of a compliant, or to any alternative meal that is also compliant with the dietary parameters corresponding to the user's profile. Accordingly, the system has the capability to provide a practical alternative, or “best fit” alternative, to accommodate less than optimal circumstances that are commonplace in the lives of many persons, e.g., when preparing to take the user's children to lunch at a fast food chain restaurant, or if the user is scheduled to participate in a business meeting at an ethnic restaurant where the user will not likely be able to choose a recommended or compliant meal. This affords a tremendous amount of flexibility to the user in the face of daily pressures, obligations, etc., and facilitates users in their long term, if not daily, adherence to a prescribed dietary regimen, and thus fosters the user's achievement of the user's goals.

In this exemplary embodiment, after developing the user profile, the user transmits to the system a request for a meal having a certain characteristic, e.g. requesting a “best fit” meal based on communicating “Burger King,” based on communicating “Big Mac,” communicating “hamburger,” etc., as shown at step 90. This request is received by the server 200 from the user's device 12, 14, 16 via an appropriate communication channel, as discussed above with reference to FIG. 1. By way of example, the user may issue this request after receiving a recommendation that is impractical, or for which the user is not presently inclined to accept. Alternatively, for example, the user may issue such a request after being asked to join in a lunch meeting at a particular restaurant, although a recommendation has already been made.

As yet another exemplary alternative regarding making of a request by a user, the user may not receive any recommendations that are pushed, i.e., sent proactively, by the system. Instead, the system may not make period recommendations, but rather may only issue requests from time to time as the user chooses, in response to a user request. For example, the user may not request a recommendation for weekend lunches, but may request a recommendation for weekday lunches. Additionally, the requests and recommendation responses may be preformed iteratively. For example, a user may eat at home all week and make healthy meals for himself, and thus not require a recommendation. However, the user may plan to dine at a restaurant on Saturday night. For example, the user, on Saturday afternoon, may submit a request to the system for a recommendation for a meal that can be purchased at a Burger King restaurant. The system may responsively recommend a particular salad available for purchase at Burger King. Recognizing that the user is not in the mood for a salad, the user may subsequently respond with a follow-up request for a recommendation for a Burger King meal including a hamburger. The system may recommend a particularly miniature burger rather than a larger (Whopper) burger. The user may subsequently respond with another follow-up request for a recommendation for a Burger King Whopper, and the system may respond with a recommendation including consumption guidelines that suggest requesting no cheese or mayonnaise, or removing the cheese and mayonnaise, and eating no more than half of the burger. Accordingly, the process may be iterative, and conversational in nature. It will be appreciated that this is particularly convenient in the email, text messaging and instant messaging contexts, and may be carried out via a PDA, wireless telephone, pager or similar mobile device. The user might not request another recommendation, or receive any recommendation from the system, until the following Saturday when the user plans to again dine at a restaurant.

The certain characteristic may be virtually anything, such as: availability at a particular food restaurant franchise, general availability at a particular type of ethnic restaurant, having a certain ingredient, being a specific food item, etc. For example, the request may be for a recommendation for a meal at a Chinese restaurant, if the user will be attending a business meeting at a Chinese restaurant.

In response to the request, the server 200 identifies a non-compliant meal for the user that does not meet the dietary parameters for the user's profile, as shown at step 92. Accordingly, the non-compliant meal is not a meal that the server would normally recommend to the user when a better, compliant meal, is a practical alternative. However, the non-compliant meal is more selected to be more closely compatible with the dietary parameters than another meal having the certain characteristic. For example, it may be the best choice from among several non-compliant alternatives.

For example, if the user's profile severely limits sodium consumption, there may not be a single meal at a Chinese restaurant that meets the user's profile. However, if the user is going in any event to eat at the Chinese restaurant, the system will help the user to make a relatively wise and/or best choice that fits within the given constraint, thus affording a high degree of flexibility to the user. The identification may be made by the recommendation engine, in view of the nutritional information in the database stored in the memory 220 of the server 200, and in view of the user's profile.

In a certain embodiment, the identification of the non-compliant meal may be made after searching a database of nutritional information to identify whether there is any compliant meal having the certain characteristic having nutritional content values that are within said dietary parameters and finding that no such meal exists.

Optionally, the system may also identify consumption guidelines for the non-compliant meal, as shown at step 94. These consumption guidelines may also be stored in the database of nutritional information stored in the memory of the server 200. These consumption guidelines may, or may not, be sufficient to bring the non-compliant meal in compliance with the dietary parameters associated with the user's profile. The consumption guidelines may be retrieved from the database of nutritional information and may, by way of example, include an instruction to the chef for preparing the non-compliant meal, e.g. fry in olive oil, not peanut oil, or no peanuts, or broil or bake but do not fry, etc., or an instruction to the user for consuming the non-compliant meal, e.g., don't eat the bun, scrape off the cheese, remove the bacon, etc. Additionally, by way of example, the system may provide portion size recommendations, e.g. eat only 4 oz., or eat only half, etc.

Communication Between System and User

As shown in FIG. 2, whether a compliant or non-compliant meal is identified, the server 200 then identifies either the compliant meal or the non-compliant meal as a recommended meal, and then transmits meal information identifying the recommended meal to the user, as shown at steps 80 and 82. More specifically, the server 200 transmits the meal information to the user, via a suitable communications channel to at least one of the devices 12, 14, 16 described above with reference to FIG. 1.

In a preferred embodiment, the transmitted meal information is “pushed”, i.e. actively sent by the server 200, to a device, such as a wireless telephone 14 or other mobile computing device, on a recurring basis according to a predetermined schedule, e.g. to provide a daily meal plan, or to provide a recommendation for a next meal before each meal.

The user then confirms to the system the meal actually consumed by the user, as shown in step 84. This may include an identification of day, identification of the daily meal (e.g., breakfast, lunch, dinner, snack, etc.), the time of day for the meal, what and how much was eaten, and what and how much was drunk. This information is provided by the user via one of his devices 12, 14, 16 and transmitted to the server 200. This information may be recorded in a food diary/log that is maintained in a database stored in the server's memory 220. This confirmation process provides feedback to the system that allows for future planning/recommendation of meals. By way of example, the user may provide a simple confirmation of the recommended meal, e.g. by sending a simple text message “Y”. In this event, the items consumed and their respective nutritional content values are already known by the system as a result of the recommendation process. Alternatively, the user may provide a confirmation that includes a description of the particular meal consumed when the particular meal consumed is different from the recommended meal. Accordingly, the user must provide a greater level of detail to allow the system to determine nutritional content values for the meal actually consumed.

After the user has sent such confirmation to the system, the system identifies a next recommended meal for the user based on the user's profile and the meal actually consumed, as shown at step 86. In other words, the system considers in recommending a next meal, a prior meal consumed. In this way, the next recommended meal may be selected to have nutritional content values selected to assist the user in complying with the dietary parameters in view of respective nutritional content values of the non-compliant meal. For example, if the last meal greatly exceeded a recommended fat content for a single meal, there can be an attempt to minimize fat content for a next meal, or series of next meals, so that the user's dietary intake tends back toward the recommended levels. The next compliant meal may be recommended to the user in a manner similar to that described above.

Further, the server may transmit a motivational message to the user, i.e. to one of the user's devices 12, 14, 16 via an appropriate communications channel. The message is preferably a relevant pre-recorded message intended to encourage the user's compliance with the dietary parameters. Preferably, the pre-recorded messages are stored in a database in the server's 200 memory 220, and are retrieved and transmitted as necessary. For example, the pre-recorded message may be in textual, audio, video, combined, or other formats.

Additionally, computer readable media storing computer readable code for carrying out the method steps identified above. The computer readable media stores code for carrying out subprocesses for carrying out the method described above.

A computer program product recorded on a computer readable medium for carrying out the method steps identified above. The computer program product comprises computer readable means for carrying out the method described above.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting.

We claim:

1. A method for providing nutritional counseling, said method comprising a computerized system:
receiving, via a communications network user information relating to a user;
developing a profile for said user, said profile being defined as a function of said user information, said profile being associated with certain dietary parameters;
receiving, via a communications network, a request from the user for a meal having a certain characteristic;
searching a database of nutritional information to identify whether any meal having the certain characteristic has nutritional content values that are within said dietary parameters; and
if no meal having the certain characteristic has nutritional content values that are within said dietary parameters, then
identifying a non-compliant meal for said user that does not have nutritional content values that are within said dietary parameters, but that is more closely compatible with the dietary parameters than another meal having the certain characteristic; and
transmitting to the user, via the communications network, meal information identifying said non-compliant meal as a recommended meal.

2. The method of claim 1, further comprising:
identifying a compliant meal for the user as a function of the user's profile, the compliant meal having nutritional content values that are within said dietary parameters; and
transmitting to the user, via the communications network, meal information identifying said compliant meal as the recommended meal.

3. The method of claim 1, wherein said meal information comprises consumption guidelines relating to the user's consumption of the alternative meal.

4. The method of claim 3, wherein said consumption guidelines are retrieved from said database of nutritional information.

5. The method of claim 3, wherein said consumption guidelines comprising an instruction for preparing the alternative meal.

6. The method of claim 3, wherein said consumption guidelines comprising an instruction for consuming the alternative meal.

7. The method of claim 1, further comprising:
receiving from the user, via the communications network, confirmation of the user's consumption of a particular meal.

8. The method of claim 7, wherein said confirmation comprises confirmation of consumption of the non-compliant meal.

9. The method of claim 7, wherein said confirmation comprises a description of the particular meal, the particular meal being different from any recommended meal identified by meal information transmitted to the user.

10. The method of claim 9, further comprising:
identifying a next compliant meal for the user as a function of the user's profile and nutritional content of the particular meal confirmed to have been consumed by the user, the new compliant meal; and
transmitting to the user, via the communications network, meal information identifying said next compliant meal as the recommended meal.

11. The method of claim 10, wherein said next compliant meal is selected to have nutritional content values selected to assist the user in complying with the dietary parameters in view of respective nutritional content values of the non-compliant meal.

12. The method of claim 1, further comprising:
transmitting to the user, via a communications network, a pre-recorded message intended to encourage the user's compliance with the dietary parameters.

13. The method of claim 1, wherein the meal information is transmitted to a mobile computing device of the user.

14. The method of claim 13, wherein the transmitted meal information is pushed to the mobile computing device on a recurring basis according to a predetermined schedule.

15. A method for providing nutritional counseling, said method comprising a computerized system:
assigning a profile to a user, said profile being associated with certain dietary parameters;
searching a database of nutritional information to identify whether any meal having the certain characteristic has nutritional content values that are within said dietary parameters;
transmitting to the user, via the communications network, meal information identifying a recommended meal, said recommended meal being a non-compliant meal having nutritional content values that are not within said certain dietary parameters; and
transmitting to the user, via a communications network, a pre-recorded message intended to encourage the user's compliance with the dietary parameters.

16. The method of claim 15, wherein the transmitted meal information is pushed to the mobile computing device on a recurring basis according to a predetermined schedule.

17. A system for providing nutritional counseling, the system comprising:
a microprocessor;
a memory operatively connected to the microprocessor;
a network interface device operatively connected to the microprocessor for communicating via a communications network; and
instructions stored in the memory and executable by the microprocessor to:
develop a profile for a user responsive to receipt of user information, said profile being defined as a function of said user information, said profile being associated with certain dietary parameters;
search a database of nutritional information to identify whether any meal having a certain characteristic has nutritional content values that are within said dietary parameters; and
if no meal having the certain characteristic has nutritional content values that are within said dietary parameters, then
identify a non-compliant meal for said user that does not have nutritional content values that are within said dietary parameters, but that is more closely compatible with the dietary parameters than another meal having the certain characteristic; and
transmit to the user, via the communications network, meal information identifying said non-compliant meal as a recommended meal.

18. The system of claim 17, further comprising instructions stored in the memory and executable by the microprocessor to:
identify a compliant meal for the user as a function of the user's profile, the compliant meal having nutritional content values that are within said dietary parameters; and
transmit to the user, via the communications network, meal information identifying said compliant meal as the recommended meal.

19. The system of claim 18, further comprising instructions stored in the memory and executable by the microprocessor to:
transmit to the user, via a communications network, a pre-recorded message intended to encourage the user's compliance with the dietary parameters.

20. A computer program product embodied on one or more computer-readable media, the computer program product adapted for communicating via a communications network and comprising:
computer-readable program code configured to:
develop a profile for a user responsive to receipt of user information, said profile being defined as a function of said user information, said profile being associated with certain dietary parameters;
search a database of nutritional information to identify whether any meal having a certain characteristic has nutritional content values that are within said dietary parameters; and
if no meal having the certain characteristic has nutritional content values that are within said dietary parameters, then
identify a non-compliant meal for said user that does not have nutritional content values that are within said dietary parameters, but that is more closely compatible with the dietary parameters than another meal having the certain characteristic; and
transmit to the user, via the communications network, meal information identifying said non-compliant meal as a recommended meal.

21. The system of claim 20, further comprising computer-readable program code configured to:
identify a compliant meal for the user as a function of the user's profile, the compliant meal having nutritional content values that are within said dietary parameters; and
transmit to the user, via the communications network, meal information identifying said compliant meal as the recommended meal.

22. The system of claim 20, further comprising computer-readable program code configured to:
transmit to the user, via a communications network, a pre-recorded message intended to encourage the user's compliance with the dietary parameters.
